(19) United States
(12) Patent Application Publication
(10) Pub. No.: US 2016/0311396 A1
(43) Pub. Date: Oct. 27, 2016

(54) BELT BUCKLE ANCHOR FOR THIN SEATS

(71) Applicant: GM Global Technology Operations LLC, Detroit, MI (US)

(72) Inventor: LARRY A. MARTIN, PLYMOUTH, MI (US)

(21) Appl. No.: 14/695,379

(22) Filed: Apr. 24, 2015

(51) Int. Cl. B60R 22/18; A44B 11/25

(52) U.S. Cl. CPC B60R 22/18; A44B 11/2503; B60R 2022/1806

(57) ABSTRACT

A number of variations may include a product comprising: a buckle anchor comprising: a body, wherein the body includes an opening constructed and arranged to accommodate a webbing; a first and a second tab, wherein the first tab extends outward from a first side of the body and wherein the second tab extends outward from a second side of the body; and a ramp, wherein the ramp extends upward at an angle from a top side of the body.

### TECHNICAL FIELD

The field to which the disclosure generally relates to includes vehicle belts.

### BACKGROUND

A vehicle may include one or more belts.

### SUMMARY OF ILLUSTRATIVE VARIATIONS

One variation may include a product comprising: a buckle anchor comprising: a body, wherein the body includes an opening constructed and arranged to accommodate a webbing; a first and a second tab, wherein the first tab extends outward from a first side of the body and wherein the second tab extends outward from a second side of the body; and a ramp, wherein the ramp extends upward at an angle from a top side of the body.

Another variation may include a product comprising: a webbing mounted buckle comprising: a buckle, an anchor bracket, and a webbing; wherein the anchor bracket is attached to the buckle with the webbing; and wherein the anchor bracket is constructed and arranged to mount to a vehicle and cause a portion of the webbing to sit laterally in the vehicle underneath the anchor bracket to reduce the height of the buckle.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a perspective view of a webbing mounted buckle with a belt anchor bracket according to a number of variations.

FIG. 2 illustrates a top view of a webbing mounted buckle with a belt anchor bracket according to a number of variations.

FIG. 3 illustrates top view of rear seating in a vehicle according to a number of variations.

FIG. 4 illustrates a perspective close-up view of a vehicle body with webbing mounted buckles comprising belt anchor brackets according to a number of variations.

### DETAILED DESCRIPTION OF ILLUSTRATIVE VARIATIONS

The following description of the variations is merely illustrative in nature and is in no way intended to limit the scope of the invention, its application, or uses.

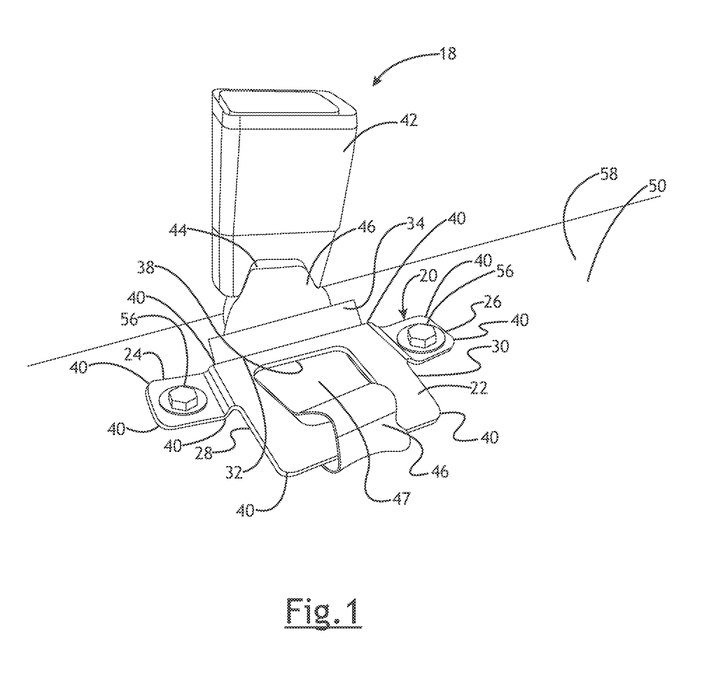

FIGS. 1-4 illustrate a number of variations including a webbing mounted buckle 18. In a number of variations, a webbing mounted buckle 18 may include a belt anchor bracket 20 which may be used to attach the webbing mounted buckle 18 to a vehicle 50 so that less space for mounting may be required. In a number of variations, a belt anchor bracket 20 may be constructed and arranged so that it may cause a portion of the webbing 46 to sit laterally in the vehicle 50 underneath the belt anchor bracket 20. This may allow the webbing 46 to have a length long enough to sew 60 the ends 48 of the webbing 46 together without increasing the vertical height of the webbing mounted buckle 18 in the vehicle 50. In a number of variations, the belt buckle anchor 20 may decrease the height of the webbing mounted buckle 18 by approximately 50-60 mm. This may allow for the use of a webbing mounted buckle 18 in areas of the vehicle 50 which may typically require a steel strap mounted buckle or a cable mounted buckle.

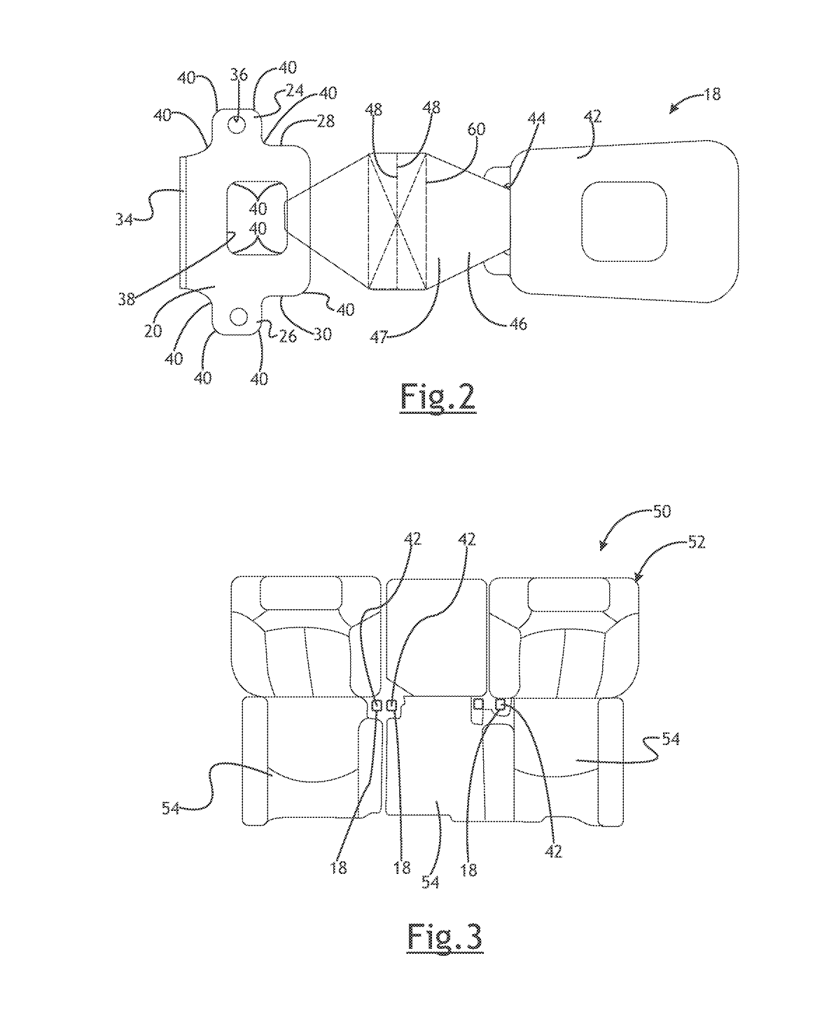

In a number of variations, a belt anchor bracket 20 may comprise a body 22 which may include a first tab 24 which may extend outward from a first side 28 the body 22 and a second tab 26 which may extend outward from a second side 30 of the body 22, variations of which are illustrated in FIGS. 1 and 2. Each tab 24, 26 may include one or more through-holes or openings 36, a variation of which is illustrated in FIG. 2, which may be constructed and arranged to accommodate one or more mechanical fasteners 56 including, but not limited to, a bolt, a variation of which is illustrated in FIG. 1. In a number of variations, the body 22 may include a cutout or opening 38 which may be constructed and arranged to accommodate a portion of webbing 46, variations of which are illustrated in FIGS. 1 and 2. The opening 38 may be any number of shapes including, but not limited to, square or rectangular. In a number of variations, the body 22 may also include a ramp 34 which may extend at an angle upward from a top portion 32 of the body 22, a variation of which is also illustrated in FIG. 1. The ramp 34 may be constructed and arranged to guide the position of the webbing 46 and buckle 42. In a number of variations, one or more of the corners 40 of the belt anchor bracket 20 may include a radius, fillet, and/or chamfer.

The belt anchor bracket 20 may comprise any number of materials including, but not limited to, steel or any number of metallic materials. The belt anchor bracket 20 may be formed in any number of variations including, but not limited to, stamping.

In a number of variations, a strip of webbing 46 may be looped through an opening 44 in the bottom of the buckle 42 and may be looped through the opening 38 in the belt anchor bracket 20, so that the ramp 34 on the belt anchor bracket 20 may be facing downward, a variation of which is illustrated in FIG. 2. The ends 48 of the webbing 46 may be then be sewn 60 to secure the buckle 42 and the buckle anchor bracket 20 together. In one variation, the ends 48 of the webbing 46 may overlap so that there may be three layers of material sewn 60 together. In another variation, the ends 48 may not overlap so that there may be two layers of webbing sewn 60 together at each end 48, a variation of which is illustrated in FIG. 2.

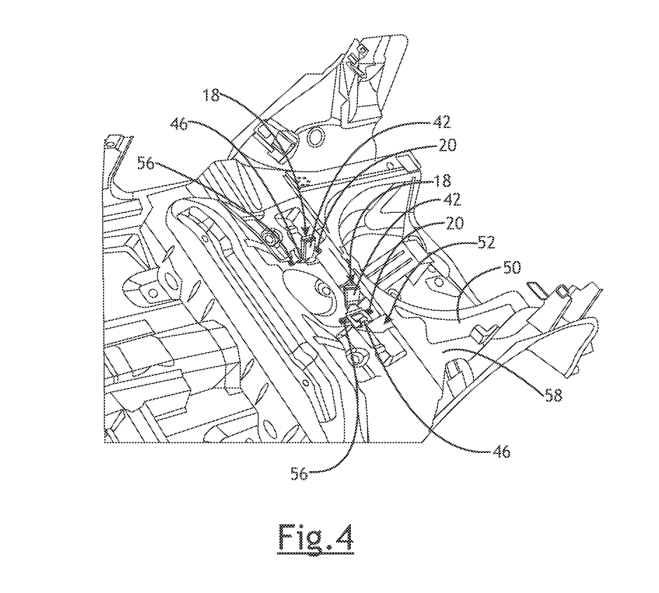

In a number of variations, the belt anchor bracket 20 may be folded over onto the top portion 47 of the webbing 46 so that the ramp 34 may be extending at an angle upward, and attached to a vehicle 50, a variation of which is illustrated in FIG. 1. This may cause a portion of the webbing 46 to sit vertically in the vehicle 50 underneath the belt anchor bracket 20 so that the height of the webbing 46 may be reduced. The webbing mounted buckle 18 may be attached to a vehicle 50 in any number of variations including, but not limited to, attaching the belt anchor bracket 20 to the vehicle 50 via one or more mechanical fasteners 56 which may extend through the openings 36 in the buckle anchor bracket tabs 24, 26, variations of which are illustrated in FIGS. 1 and 4.

Referring to FIGS. 3 and 4, in a number of variations, the webbing mounted buckle 18 may be attached to areas of a vehicle 50 which may have limited space and/or thin seats 54, including, but not limited to, the rear row seating 52 of a vehicle 50. In a number of variations, the use of a webbing mounted buckle 18 in areas of a vehicle 50 which may have limited space and/or thin seats may improve warranty issues as well as improve child seat accommodations. The use of the webbing mounted buckle 18 may also provide an occupant with additional space in the vehicle 50 where the webbing mounted buckle 18 may be mounted. The seat cushion 54 may be constructed and arranged in the vehicle 50 to provide space and head clearance for an occupant. The seat cushion 54 may also be constructed and arranged in the vehicle 50 to package the thickness of the foam of the seat cushion 54 which may be required for comfort and to package the safety belt buckle, variations of which are illustrated in FIG. 3. In a number of variations, the use of the webbing mounted buckle 18 may enable the seating row of the vehicle body 58 to sit higher in the vehicle 50 which may allow for additional space under the vehicle floor 64 which may be used as additional storage space for any number of vehicle components including, but not limited to, a battery pack in electric vehicles which may be located under the rear seating 52.

The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a product comprising: a buckle anchor comprising: a body, wherein the body includes an opening constructed and arranged to accommodate a webbing; a first and a second tab, wherein the first tab extends outward from a first side of the body and wherein the second tab extends outward from a second side of the body; and a ramp, wherein the ramp extends upward at an angle from a top side of the body.

Variation 2 may include a product as set forth in Variation 1 wherein the opening in the body is square.

Variation 3 may include a product as set forth in Variation 1 wherein the opening in the body is rectangular.

Variation 4 may include a product as set forth in any of Variations 1-3 wherein the ramp is constructed and arranged to guide the position of a buckle.

Variation 5 may include a product as set forth in any of Variations 1-4 wherein the first and the second tab each include at least one opening which is constructed and arranged to accommodate at least one mechanical fastener.

Variation 6 may include a product as set forth in any of Variations 1-5 wherein the buckle anchor comprises a metal.

Variation 7 may include a product as set forth in any of Variations 1-6 wherein the buckle anchor is attached to a buckle.

Variation 8 may include a product as set forth in any of Variations 1-7 wherein the buckle anchor is attached to the buckle with a webbing.

Variation 9 may include a product as set forth in any of Variations 1-8 wherein the webbing is looped around the opening in the body of the buckle anchor and an opening in the buckle and wherein the webbing is sewn together.

Variation 10 may include a product as set forth in any of Variations 1-9 wherein the buckle anchor is attached to a vehicle.

Variation 11 may include a product as set forth in Variation 10 wherein the buckle anchor is attached to the vehicle so that a portion of the webbing is seated laterally in the vehicle underneath the buckle anchor so that the height of the webbing and the buckle is reduced.

Variation 12 may include a product as set forth in any of Variations 10-11 wherein the buckle anchor is attached to the vehicle via at least one mechanical fastener.

Variation 13 may include a product comprising: a webbing mounted buckle comprising: a buckle, an anchor bracket, and a webbing; wherein the anchor bracket is attached to the buckle with the webbing; and wherein the anchor bracket is constructed and arranged to mount to a vehicle and cause a portion of the webbing to sit laterally in the vehicle.

Variation 14 may include a product as set forth in Variation 13 wherein the webbing mounted buckle is attached to a vehicle.

Variation 15 may include a product as set forth in Variation 14 wherein the webbing mounted buckle is attached to the vehicle so that a portion of the webbing is seated laterally in the vehicle underneath the anchor bracket so that the height of the webbing and the buckle is reduced.

Variation 16 may include a product as set forth in any of Variations 14-15 wherein the webbing mounted buckle is attached to the vehicle via the anchor bracket.

Variation 17 may include a product as set forth in any of Variations 13-16 wherein the anchor bracket comprises a body, wherein the body includes an opening constructed and arranged to accommodate the webbing; a first and a second tab, wherein the first tab extends outward from a first side of the body and wherein the second tab extends outward from a second side of the body; and a ramp, wherein the ramp extends upward at an angle from a top side of the body.

Variation 18 may include a product as set forth in any of Variations 14-17 wherein the webbing mounted buckle is attached to a rear row seating area of the vehicle.

The above description of select variations within the scope of the invention is merely illustrative in nature and, thus, variations or variants thereof are not to be regarded as a departure from the spirit and scope of the invention.

1. A product comprising:
a buckle anchor comprising:
a body, wherein the body is planar and includes an opening constructed and arranged to accommodate a webbing;
a first and a second tab, wherein the first tab extends outward from a first side of the body and wherein the second tab extends outward from a second side of the body; and
a ramp, wherein the ramp is linear and extends upward at an angle from a top side of the body.

2. The product of claim 1 wherein the opening in the body is square.

3. The product of claim 1 wherein the opening in the body is rectangular.

4. The product of claim 1 wherein the ramp is constructed and arranged to guide the position of a buckle.

5. The product of claim 1 wherein the first and the second tab each include at least one opening which is constructed and arranged to accommodate at least one mechanical fastener.

6. The product of claim 1 wherein the buckle anchor comprises a metal.

7. The product of claim 1 wherein the buckle anchor is attached to a buckle.

8. The product of claim 7 wherein the buckle anchor is attached to the buckle with a webbing.

9. The product of claim 8 wherein the webbing is looped around the opening in the body of the buckle anchor and an opening in the buckle and wherein the webbing is sewn together.

10. The product of claim 7 wherein the buckle anchor is attached to a vehicle.

11. The product of claim 10 wherein the buckle anchor is attached to the vehicle so that a portion of the webbing is seated laterally in the vehicle underneath the buckle anchor so that the height of the webbing and the buckle is reduced.

12. The product of claim 10 wherein the buckle anchor is attached to the vehicle via at least one mechanical fastener.

13. A product comprising:
a webbing mounted buckle comprising:
a buckle;
a webbing;
an anchor bracket, wherein the anchor bracket comprises a body, wherein the body is planar and includes an opening, a ramp which extends at an angle from the body, and a first tab and a second tab which extend laterally from opposite sides of the body;
wherein the webbing extends through the opening in the body and through an opening in the buckle; and
wherein the anchor bracket is constructed and arranged to mount to a vehicle and cause a portion of the webbing to sit laterally in the vehicle.

14. The product of claim 13 wherein the webbing mounted buckle is attached to a vehicle.

15. The product of claim 14 wherein the webbing mounted bracket is attached to the vehicle so that a portion of the webbing is seated laterally in the vehicle underneath the anchor bracket so that the height of the webbing and the buckle is reduced.

16. The product of claim 14 wherein the webbing mounted buckle is attached to the vehicle via the anchor bracket.

17. (canceled)

18. The product of claim 14 wherein the webbing mounted buckle is attached to a rear row seating area of the vehicle.

19. The product of claim 1 wherein the ramp extends at an angle greater than 90 degrees from a surface of the body.
